(19) United States
(12) Patent Application Publication
(10) Pub. No.: US 2005/0097022 A1
(43) Pub. Date: May 5, 2005

(54) System and method for investment in a portfolio of entertainment productions

(76) Inventor: Robert Silman, London (GB)

Correspondence Address: DARBY & DARBY P.C., P. O. BOX 5257, NEW YORK, NY, 10150-5257, US

(21) Appl. No.: 10/698,839

(22) Filed: Oct. 31, 2003

(51) Int. Cl. G06F 17/60

(52) U.S. Cl. 705/36

(57) ABSTRACT

The invention relates to a system and method for raising a fund from investors for the purposes of distributing to a portfolio of startup investments, where each startup investment within the portfolio has been separately capitalized. Additionally, the invention relates to a system and method for investing in a milestone based portfolio of startup investments. The investment then must meet certain preset criteria (“milestones”) before additional capital is allocated to the investment.

### BACKGROUND OF THE INVENTION

1. Field of the Invention

The invention relates to a system and method for raising a fund from investors for distribution to a portfolio of investments, particularly startup entertainment investments. Each startup investment within the portfolio is separately capitalized, and reallocation of capital and/or profits from one investment to another is prohibited. Additionally, the invention relates to a system and method for investing in a milestone based portfolio of startup investments. The investment then must meet certain preset criteria (“milestones”) before additional capital is allocated to the investment.

2. Discussion of the Related Art

Investment in commercial entertainment projects, such as theatrical productions, is well known, but in general has been limited to a particular theatrical production at a particular time and place. Typically, such an investment in an entertainment project, for example, a theatrical production, carries a high risk. Many, if not most, theatrical productions end in financial failure where the original investment is completely lost. A small number of theatrical productions may recoup their investment but not make a substantial profit. An even smaller number of theatrical productions become hits and reap substantial profits.

A rational way to spread the risk and maximize the possibility of profit would be to invest in a portfolio of productions so that the potential profit from the few productions that succeed would more than offset the potential loss from the many that fail. Though an investor could seek to invest in a portfolio of productions for himself, this is difficult because the investor does not have the time, contacts, or expertise to find such productions. Typically, producers offer productions to investors. Though producers have been known to offer a portfolio of productions to their investors, these are commonly blind, i.e. the producer manages the investment capital and chooses the productions after the investor has made the investment. Rarely, the producer may indicate a specific set of productions within a portfolio. But, in no case has a producer offered a portfolio of productions with a predetermined capital allocation for each production (with or without milestones) and with constraints that prevent the reallocation of capital and/or profits from one production to another. By forbidding additional investment in a production which has failed to meet its success criteria (milestones) limits a potential loss in that production; and by forbidding the transfer of capital and/or profit between productions within a portfolio improves and maximizes the spread of risk across a portfolio.

In conventional investment plans, there is a potential conflict of interest between the producer and the investor which make it important, according to the invention, that there be no reallocation of capital and/or profit between productions within a portfolio. For example, typically, the producer receives royalties whenever a theatrical production is performed, and the royalty is paid to the producer regardless of the profitability of the theatrical production. In such circumstances, a producer may chose to reallocate the money from a profitable theatrical production to subsidize a production that is not profitable. In this way, the producer continues to receive the royalty from both theatrical productions, at the cost of a profit that would otherwise go to the investor, and even though investors in a subsidized production may experience losses. This is not to imply that the producer has a conscious intent to deprive the investor of profit for the producer's own personal gain. The producer might genuinely believe that by keeping a loss-making show in production, e.g. by subsidizing it with the profits and/or capital from a successful show, the loss making show might eventually “turn the corner” and become profitable, to the advantage of both producer and investor. Similarly a producer might genuinely believe that a show which has failed to achieve profitability in one venue might have a better chance in another, and therefore will use all the available capital for that show in producing it elsewhere. However, such judgments are subjective and may too easily be influenced by self-interest or unrealistic optimism. The invention imposes objective financial constraints on the portfolio at the start, which must be adhered to, and which cannot be overruled by a producer's subjective judgment.

Other types of investment methods are known in the art. U.S. Patent Publication No. 2002/0198763 to Pittelli discloses a method for individual artists to be funded. Individual artists submit works that are reviewed by either a panel or by popular vote from consumers. From the group of artists who submit works, either the panel or the consumers determine which individual artist should be eligible for possible funding. An artist only remains eligible for a fixed amount of time and must reach a “funding milestone” in that period. Investors then invest a set amount in the eligible artist. Once the amount of the cumulative investment reaches the “funding milestone” the artist receives the funding. The funds are used to support the commercialization of the artist, e.g. recording an album, merchandising and marketing, tour and/or financial security for the artist's future. However, the investor is not informed as to what the “funding milestone” is and to what use his or her contribution is put.

Additionally, investors do not receive profits or bear losses in the traditional sense. An investor of a funded artist only receives “membership privileges”, i.e. discounts on merchandise and tickets, access to “special receptions” with the artist, etc. Investors do not receive any other return on their investment. Investors do not reap any actual profit from their investment if the artist becomes successful, nor do they bear any further losses if the artist does not become successful. That is, Pitelli is concerned with supporting artists through an organized method of philanthropy it does not address risk versus reward strategies for commercial investment. Pitelli also provides that if the minimum funding is not met for a particular artist, the money can be refunded to the investor, transferred to another artist or kept in a fund for future use depending on the desires of the individual investor. Thus, there is a single funding milestone, which is based on how much money is invested. The artist is not put through “stages” to determine if or how successful the artist can be. Either enough consumers like the artist's work initially and are willing to invest to a predetermined level, in which event the artist uses funds for commercialization, or the artist does not receive enough funds and is not funded. Pitelli's “funding milestone” is no more than a minimum amount of money that must be invested in the artist prior to distribution to the artist, e.g. to fund a recording contract.

U.S. Patent Publication No. 2002/0123954 to Hito discloses an investment method to protect an investor's capital investment. Hito's investors deposit a capital investment in an interest bearing account. Once the account has generated a monthly interest payment, the interest is invested in an option contract, e.g. the value of the Yen, set to end at the end of the next month. If the investor's prediction about the option is correct (i.e. the Yen is strong against the U.S. Dollar) the investor can double the interest amount invested. Then the current and the previous month's interest along with the profits are invested in another options contract. If the investor was incorrect, the investor loses the interest amount invested, and the system then invests the next month's interest earned from the principal and the investor can make another prediction. The principal is never invested and the key to Hito's method is to never place the principal in a risky investment, only the interest.

U.S. Patent Publication No. 2002/0138384 to Malackowski et al. (“Malackowski”) discloses a method of minimizing risk in an investment. Investors invest in a venture and receive an ownership interest in an intellectual asset. The venture is then gauged by established parameters. Such parameters may include sales or profit goals, customer penetration, strategic partnership agreements, establishing a distribution network, or other factors fundamental to the success of the venture. Failing to meet the established parameters can include the ending of the venture. Once the parameters are not met, Malackowski discloses a method of using the intellectual asset to allow the investors to receive a tax deduction to offset the losses incurred from the failure of the venture. Malackowski assumes that an investor's entire investment is invested in the venture and uses the established parameters to determine when or if an interest in the intellectual asset transfers to the investors, and then to a charity, to minimize the investor's loss. Malackowski does not contemplate multiple funding milestones to limit the risk of investment, only how the investor can receive a tax benefit when an entire investment is lost.

There is a need in the art for a method of investment that secures an investor from some risk by creating a portfolio of startup investments which prohibits the reallocation of capital and/or profits from one startup investment within the portfolio to another that has exhausted its capital or is losing money. Further, there is a need for the startup investments within the portfolio to have preset investment milestones which are portions of the total startup investment. The milestone determines if the startup investment is worthy of its next portion of funding, and either funding the investment with the next portion or retaining the remaining portions for return to the investor.

### SUMMARY OF THE INVENTION

The invention provides a system and method for initiating and managing a portfolio of startup investments, preferable entertainment investments. The step of selecting a portfolio of investments includes selecting a plurality of investments wherein the investments are startup investments and/or non-established investments. Typically startup investments are where the capital invested finances a new enterprise and does not finance an existing enterprise. This is distinguished from issued stocks, bonds, commodities, or other financial instruments that are typically traded on an exchange and can be traded by the general public without restriction. In a startup, the investor is investing in the future profitability of the new enterprise. Typically, the investor has no historical data regarding the profitability of the new enterprise. The principal, if not the only, knowledge about the investment the investor may receive is the resume of the key personnel and what business the enterprise will undertake.

In a preferred embodiment, the investment method of the invention includes a milestone based fund of entertainment projects such as theatrical productions, motion pictures, musical events, theatrical readings and the like (“productions”). The invention relates to a method of investing in projects wherein one producer offers multiple productions in a portfolio and the investor invests in the portfolio instead of a single production. Additionally, the invention prevents the producer from taking the capital and/or profits from a successful production and reallocating to another production that is operating at a loss. Software to implement the invention is also provided.

The portion of the fund that is allocated to each production within the portfolio is limited to a predetermined capital allocation composed of seed capitalization and commercial capitalization and any unspent capital and/or profit that may arise from a specific production cannot be reallocated to any other production within the portfolio. Instead the unspent capital is returned to the fund for distribution to the investors. Seed capitalization can be allocated to the production prior to commercial capitalization to establish the feasibility of commercial capitalization. The first commercial capitalization is the capital investment necessary for developing the production to first profitability. The production then must operate for a period of time and meet milestones before additional capital (second and/or third commercial capitalizations, etc.) from the fund, up to the predetermined maximum capitalization limits for that production, is allocated to the production. If the production does not meet the milestone criteria for additional capital, the remaining unused capital reserved for that production within the fund is not allocated nor is it reallocated to any other production within the portfolio, but is instead kept within the fund for distribution to the investors. Additionally, the invention ensures that any profit that may arise from a specific production that does not meet its milestone criteria is similarly returned to the fund for distribution to the investors and cannot be reallocated to another production within the portfolio.

The portfolio investment method of the present invention limits funding to a maximum capitalization in any one production and stages the commercial capitalization in that production based on preset milestone criteria. Once the maximum capitalization, milestone criteria and commercial capitalizations are set for each individual production, the portfolio investment method sets strict rules governing the allocation of the invested funds. In the case of theatrical productions, a funded production of the invention is typically arranged in stages, where the seed capitalization is used to develop the production through readings, workshops and out of town tryouts to determine whether it is worth proceeding to the first commercial capitalization. Typically, the first commercial capitalization includes the costs of the commercial development of the production prior to break-even or profitability at a first commercial venue. Here the production is tested to determine if the production warrants further investment to move the production to a larger venue (second commercial capitalization) and/or to mount the production in another territory (third commercial capitalization). If any one stage of commercial capitalization does not indicate that the production may have success in the larger venue or other territory, such further investment in the production will cease and the investors will be refunded the portion of their investment that was not invested in the seed and first, second, or further commercial capitalizations of the production, together with any unused and/or recouped capital and/or profit from the seed and first, second or further commercial capitalizations of the production.

The portfolio investment method includes the steps of selecting a portfolio of startup investments for funding and determining, at least for each startup investment in the portfolio, a seed capitalization and a first commercial capitalization. The seed capitalization can be advanced prior to the capital contribution of the investors or can be part of the capital contribution. Advancing the seed capitalization allows the startup investment to be developed prior to its selection as one of the portfolio startup investments and the seed capital can be recovered as part of the capital contribution. Alternately, a startup investment can be selected without requirement for a development process requiring seed capitalization. A second, third or multiple commercial capitalizations for some or all of the startup investments may be determined. Once all the capitalizations are determined, a maximum capitalization for each startup investment can be calculated as the sum of the seed and the commercial capitalizations. A portfolio capitalization is also determined and can equal the sum of the maximum capitalizations for all of the startup investments. Milestones for the startup investments are also determined. Milestones are preset criteria that relate to the profitability of the investment. The investment of the second (and further) commercial capitalizations can be linked to the reaching of a milestone.

A capital contribution is received from one or more investors and the sum of the capital contributions are equal to the portfolio capitalization. A first portion of the capital contribution can be invested into each of the startup investments, wherein the first portion invested in the investment is less than or equal to either the seed capitalization and/or the first commercial capitalization. Once the startup investments are capitalized and begin to operate, it is determined if the milestone for the startup investment has been met. The investments where the milestone is met are milestone investments and the investments where the milestone is not met are restricted investments. The investment of a second (and further) portion of the capital contribution into each of the milestone investments is permitted, and the second (and further) portion invested is less than or equal to the second (and further) commercial capitalization. Conversely, investment of the second (and further) commercial capitalization into the restricted investments is forbidden.

The invention may preferably include a fund for implementing investments in the portfolio. The fund can comprise any appropriate legal entity, for example, a limited liability company (LLC) or a limited liability partnership (LLP). The fund can be specific for each portfolio or can oversee multiple portfolios. In one embodiment, the fund can be limited so that it cannot operate outside of the initially invested portfolio.

In a preferred embodiment, the portfolio of startup investments can be a portfolio of theatrical productions and the fund can be an LLP or LLC. The investors are partners in the fund and share in its profits and losses in proportion to the level of their investment, but the investors do not administer the fund and they have no managerial involvement with the productions. The fund can be administered, for example, by a person or entity with the powers of a general partner or a manager to oversee the development and performance of the productions on behalf of the fund. Alternately, management of the fund may be delegated to one or more administrators or one or more producers or producing entities.

Another embodiment for the fund is a company that issues stock on an exchange, i.e. a corporate fund. The corporate fund performs the same functions as an LLP or LLC except that the investors are not partners, but shareholders. In one embodiment the company's only assets are the capital investment in the productions. Shareholders purchase a certain number of shares required to provide a capital contribution matching the portfolio capitalization. The shares can then be traded and valued based on the performance of the productions. The investors are preferably free to buy and sell their shares at will.

The step of selecting a production includes the step of selecting one or more productions comprising the portfolio. The portfolio's contents, including the number and type of productions, can be selected by a manager of the fund. The manager may select the portfolio's contents either prior to soliciting the capital contribution, during receipt of the capital contribution or after receipt of the capital contribution, e.g. a closed fund, an open fund, or a semi-closed fund described in further detail below. The number and/or type of productions can be dependant upon the aggregate capital contribution received from the investors.

The step of determining the seed capitalization of the production can include purchasing of an option for the rights to the production. The rights acquired are typically to further develop the investment without infringing the rights of others. Additionally, the seed capitalization can further include the costs for developing the production by hiring a director, scriptwriter or actors and through readings, workshops, out of town tryouts, etc. Seed capital may have been invested prior to the production being selected as accrued seed capitalization, or after the production is selected as further seed capitalization. These and other try-out costs will be apparent to those of ordinary skill in the arts of producing and financing entertainment projects and productions.

The step of determining the first commercial capitalization of an investment is determining the amount of money needed to take the investment to profitability. In general, the first commercial capitalization is enough capital to cover the costs of bringing the investment to a point where it can generate a profit.

For an entertainment embodiment, the first commercial capitalization for a production includes determining the production costs necessary for opening the production to the public at a first commercial venue, such production costs to include fees paid to managers, agents, writers, performers, designers, directors, prop supervisors, costume supervisors, electricians, sound providers and carpenters. Other production costs are the creation of sets, props, costumes, wigs, transportation, consumables, theater rental deposit and maintenance, rehearsal costs including script copying, rehearsal rooms, travel and related expenses. Additional costs are for marketing, advertising and public relations, general administration expenses including legal fees, accounting fees, insurance, travel expenses, and administrative office costs, and bonds to cover salaries as well as a reserve to cover weekly losses during a short run if the production fails to break even after opening to the public. These and other capitalization costs will be readily apparent to persons of ordinary skill in the art of producing and financing entertainment projects and productions.

The step of determining the maximum capitalization of the production includes considering all of the items set forth above for additional venues such as a larger venue or a venue in a different city or country. The maximum capitalization includes the sum of the seed and first commercial capitalization and all subsequent commercial capitalizations. Subsequent commercial capitalizations are the capitalizations required to advance the profitability of an already profitable investment. For example, (i) a Broadway production typically costs more than an off Broadway production and a second commercial capitalization is typically required to fund the costs of transferring a successful off Broadway production to Broadway, and (ii) a London production of a successful New York production will have its own production costs and a third commercial capitalization is required to finance the costs of opening the production in London.

The step of determining a milestone for the production includes setting at least one success criterion and/or failure criterion for each stage of a production. These criteria are typically performance based, such as audience attendance levels, ticket sales, and length of run. Such criteria will determine for example whether the weekly box office receipts exceed the weekly running costs to a sufficient extent to recoup the seed and first capitalizations and generate sufficient profit to warrant a second stage (e.g. transfer of the production to Broadway when the off Broadway venue is running at maximum box office attendance) and/or a third stage (opening the production in a different territory or city, e.g. a production in London in addition to New York). Additionally, the step of determining a milestone optionally includes determining one or more milestones for the second and further stages of the production, also called first milestones, second milestones, etc.

The method further includes a step of forbidding second (and further) commercial capitalizations to be spent on the production if the milestone criteria are not met (e.g. forbidding the extra cost of a Broadway transfer to an unprofitable off Broadway production or to a profitable off Broadway production which is not selling out) and permitting second (and further) commercial capitalizations to be spent on the production if the milestone criteria are met (e.g. permitting the extra cost of a Broadway transfer to a profitable off Broadway production which is selling out)

The present invention spreads the risk of investment among productions and each of the stages of each production so as to reduce the potential overall loss and increase the potential overall profit to the investor. If the production or stage of the production does not meet the milestone, the remaining stages of the production are cancelled and the portion of the capital contribution allocated to that production is returned to the fund. If the production or stage of the production meets the milestone, the portion of the capital contribution allocated to the next stage of the production can be invested.

The invention only permits the capital allocated for or profits earned from one of the productions to be reinvested in the same production. This safeguard guarantees that the investor's capital contribution is allocated exactly as proposed and only successful productions continue to be financed from the fund.

Examples of how the investments and profits can be managed are as follows. For the restricted investments, all of an unspent portion (if any) of the seed and the first commercial capitalizations and a full amount of the second (and further) commercial capitalization and all profit (if any) from the first commercial capitalization is returned to the fund. For the milestone investments, all of any unspent portion (if any) of the maximum capitalization and all profit (if any) from all stages of capitalization is returned to the fund.

In alternate embodiments, all of the unspent capital and profits from the milestone investments are not returned to the fund in the first instance. For example, the first milestone profit is a profit earned by the investment before the second portion is invested and can be reinvested into the milestone investment that earned the profit. Combinations can also be formed where a portion of the first milestone profit can be returned to the fund and the remainder of the first milestone profit can be reinvested into the milestone investment that earned the profit i.e. 50/50; 75/25; etc. Similarly, second (and further) milestone profits can be reinvested in the milestone investment in the same manner as the first milestone profit. However, after all of the stages have run their course, all unused capital and all profit from the last stage of each production is returned to the fund.

Additionally, investments where the second commercial capitalization is not determined are limited investments and the handling of their capitalization and profits is similar to the restricted investments. For both the restricted and the limited investments, all of an unspent portion (if any) of the seed and the first commercial capitalizations and all profit (if any) from the first commercial capitalization is returned to the fund.

The capital and/or profits from all the milestone, restricted and limited investments in the portfolio which are returned to the fund are summed, to form a portfolio cumulated balance. The portfolio cumulated balance is, in a preferred embodiment, kept within the fund and is not available for investment in any other portfolio of investment.

All profits and unspent capital comprising a cumulated balance are distributed to each investor in proportion with the investor's capital contribution. Typically, the investor will receive 100% of any distribution from the fund (in proportion with the investor's capital contribution to the fund) until the full sum of the investor's principal contribution has been returned, and then profit from the fund will be divided in equal shares between the investor and managing general partner or other such managing entity. The fund's rules of distribution for the return of the cumulated balance to the investor and the division of profit between the investor and the fund manager can be divided differently or geared to a sliding scale. The rules of distribution can also take into account the manner in which the profits are received by the investor from the fund. For example, the profits can be distributed as cash, stocks, bonds or kept “on account” for investment in another portfolio. Thus, an investor can receive a return from the cumulated balance in any form either the investor or the fund determines.

In an embodiment where the fund is an LLP, all unspent capital and all profits from all investments are returned to the LLP for distribution to the investors according to the rules of distribution. In the preferred embodiment, the rules of distribution are based on the cumulated balance of the portfolio. A simple example consists of a portfolio of two investments. Both investments require a maximum capitalization of $1 million, for a portfolio capitalization of $2 million. The first investment loses $800,000, leaving $200,000 as unspent capital to be returned to the LLP. The second investment utilizes its entire $1 million but recoups its investment and makes a further $1 million in profit. This results in $2 million being returned to the LLP. Thus the total return from both investments to the LLP is $2.2 million, of which $2.1 million is distributed to the investors (made up of $2 million returned as the 100% return on the original capital investment, and $100,000 distributed as part of a 50% split of profit with the managing partner). This embodiment ensures that the investors' entire capital contribution is recovered before profits are divided. This is to be contrasted with rules of distribution on an ‘investment by investment’ basis which would result in $200,000 being returned to the investor from the first investment and $1.5 million from the second (made up as $1 million returned as the 100% return on the original capital investment, and $500,000 distributed as part of a 50% split of profit with the managing partner). Using the investment by investment rule of distribution, the investor would lose $300,000 of the original invested capital despite the fact that the cumulated balance was in profit.

The step of selecting an investor, in one embodiment, includes a selection process based on a private offering, as regulated by National and/or State law, where only accredited investors are sought. Generally, selected investors must contribute at least a set minimum amount of capital, the “capital contribution”, to the fund. In one embodiment, once the capital contribution is invested, the investor cannot withdraw the capital contribution. However, the investor may contract with third parties to exchange the investor's contribution in the fund.

The step of selecting an investor, in another embodiment, can include a market in the portfolio fund. For example, the selecting process can be based on a public offering, as regulated by National and/or State law, soliciting investment from the public in shares or units of an authorized fund, which shares or units have a daily altering share or unit value (on the basis of the daily altering performance of the startup investments and the daily altering performance of the stock market in general) which shares or units can be traded on the stock exchange.

The step of receiving the capital contribution from the investor further includes a closed fund or an open fund. In the closed fund, the fund is closed to new productions. Each production is selected and the production's respective seed, first, and subsequent (if any) commercial capitalizations are determined prior to receiving the capital contributions. In the closed fund, prior to making a capital contribution, the investor is fully aware of (a) the management structure of the fund, including the manner in which profits or losses are distributed, (i.e. the rules of distribution) (b) the nature and type of productions in a portfolio (i.e. the selection which has been made), (c) the intended capital allocation for each production, (d) the milestones to be met by each production and (e) the results if a production meets or does not meet the milestone. In the open fund, the fund is open to new productions. The investor is fully aware of the management structure of the entity, including the rules of distribution, but productions are selected only after a minimum aggregate capital contribution is raised. The minimum aggregate capital contribution is determined by either the fund or the manager. Thereafter, the investor in the open fund receives the same information set forth in points (b)-(e) above. Optionally, a semi-closed fund can also be offered to investors wherein a certain number of productions are selected prior to receiving capital contributions and the remaining productions are selected after receiving the capital contributions. It will be apparent to persons of ordinary skill in the arts of producing and financing entertainment projects and productions that different funds may be open to investors based on different investment information, such as different combinations of the types of information exemplified above. For example, funds are to be structured, and offered on the basis of information as may be appropriate and/or legally required, depending on the type and location of the fund. All such embodiments are encompassed by the invention. The key difference between closed and open funds (or any combination of the two) is this: in the closed fund, investors make their investment with prior knowledge of the productions that have been selected. In the open fund, investors make their investment without prior knowledge of the productions that have been selected. In these preferred examples, the management of the investment and productions is identical in both cases, namely that milestones and capitalizations are determined for each production prior to any investment in that production by the fund, and that after milestones and capitalizations are determined the fund cannot reallocate capital and/or profits from one production to another.

In an embodiment of the invention, the seed, commercial and maximum capitalizations of the productions within a portfolio are determined such that the portion of the capital contribution invested in any particular production cannot be changed or reassigned to other productions within the portfolio at all, or in another embodiment, cannot be changed or reassigned without a majority (51%), or a supermajority (e.g. a range of about 70% through about 90%), vote of the investors on a per-investor, or preferably, a per-share of capital contribution basis.

Another embodiment includes that the step of selecting the production for the portfolio is such that once the portfolio has been established; the productions within the portfolio cannot be changed without a majority or supermajority vote of investors.

These and other features of the present invention can be embodied, separately or combined, into a computer program to allow the investment portfolio to be implemented, monitored and/or controlled electronically.

### BRIEF DESCRIPTION OF THE DRAWING FIGURES

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIGS. 1A-1C are flow charts illustrating a portfolio investment method of the present invention;

FIGS. 2A-2C are flow charts illustrating methods by which the unspent capital and profits are returned to the fund;

FIG. 3 is a flow chart illustrating a method for determining a portfolio cumulated balance;

FIG. 4 is a flow chart illustrating a method of distributing the portfolio cumulated balance;

FIGS. 5A and 5B are a flow chart illustrating an embodiment of a portfolio investment method of the present invention;

FIG. 6 is a flow chart illustrating methods for selecting and informing an investor;

FIGS. 7A-7C are flow charts illustrating a third embodiment of a portfolio investment method of the present invention; and

FIG. 8 is a flow chart illustrating additional steps for managing theatrical productions using the above embodiments.

### DETAILED DESCRIPTION OF THE PREFERRED EMBODIMENT

3. Definitions

The terms used in this specification generally have their ordinary meanings in the art, within the context of this invention and in the specific context where each term is used. Certain terms are discussed below, or elsewhere in the specification, to provide additional guidance to the practitioner in describing the methods of the invention and how to make and how to use them. The scope and meaning of any use of a term will be apparent from the specific context in which the term is used.

The term “startup” means a new business venture in its earliest stage of development. This can be any business venture and a preferred venture is a theatrical production.

The term “portfolio” means two or more startup investments.

The terms “seed capital” and “seed capitalization” mean money used for the seed investment in a startup venture or production. The money can be used, for example, for proof-of-concept, market research, acquisition of rights, or initial development. Seed capitalization is the development cost to take the startup investment to a point where a first commercial capitalization can be made. Only some investments require seed capital.

The term “first commercial capitalization” means a portion of the capital contribution allocated to startup investments that operate the investment in its first commercial stage with the intention of making a profit. Second and third commercial capitalizations are further investments of capital into the investment once the investment has reached the appropriate milestone to further fund the investment and are the expansion costs associated with increasing the profitability of the startup investment.

The term “portfolio capitalization” means the amount required to capitalize the entire portfolio. Typically, the portfolio capitalization can equal the sum of the maximum capitalizations of all the investments. Additionally, there can be central costs related to the management of the fund, as opposed to the capitalization costs for the management of the productions, which could be added resulting in a portfolio capitalization in excess of the maximum capitalization.

The term “milestone” means a significant accomplishment; intermediate goal or a significant event in the life of a project. Milestones of the invention are preset criteria that relate to the worth and/or profitability of the investment.

The term “limited investment” means an investment that receives, at most, seed capitalization and a first commercial capitalization. The investment may be limited due to the nature of the investment or the time span in which the investment can operate. An example of a limited investment can be a production that has a limited production run because of the season (e.g. A Christmas Carol) or the star of the production (e.g. Joan Rivers) or any other limiting factor.

The term “staged investment” means an investment that has at least one milestone. The investment can receive seed capitalization, first and second commercial capitalization, or as many commercial capitalizations based on the number of milestones set.

The term “milestone investment” means a staged investment that has reached one or more milestones that determined the profitability or worth of the investment. A milestone investment is a staged investment where at least one milestone has been met to allow additional funds to be allocated to the investment.

The term “restricted investment” means a staged investment that has not reached its milestone. The funding earmarked for investment after the milestone is never invested. A restricted investment may be profitable but not profitable enough to warrant further investment of capital.

The term “manager” means the person(s) or entity responsible for the overall strategy and management of the fund.

The term “first milestone profit” means a profit earned by the investment before the second portion of the capital contribution is invested. Accordingly a “second milestone profit” and a “third milestone profit” are profits earned before the third and fourth portions of the capital contribution are invested, respectively.

The term “restricted profit” means a profit earned from a restricted investment.

The term “limited profit” means a profit earned from a limited investment.

The term “closed fund” means each production is selected and each production's respective seed, first, and subsequent (if any) commercial capitalizations are determined and the investor is informed of said prior to investing the capital contribution.

The term “open fund” means each production is selected and each production's respective seed, first, and subsequent (if any) commercial capitalizations are determined and the investor is informed of said after investing the capital contribution.

The term “semi-closed fund” means a certain number of productions are selected prior to receiving capital contributions and each production's respective seed, first, and subsequent (if any) commercial capitalizations are determined and the investor is informed of said prior to investing the capital contribution. Further, the remaining productions are selected after receiving the capital contributions and each production's respective seed, first, and subsequent (if any) commercial capitalizations are determined and the investor is informed of said after investing the capital contribution.

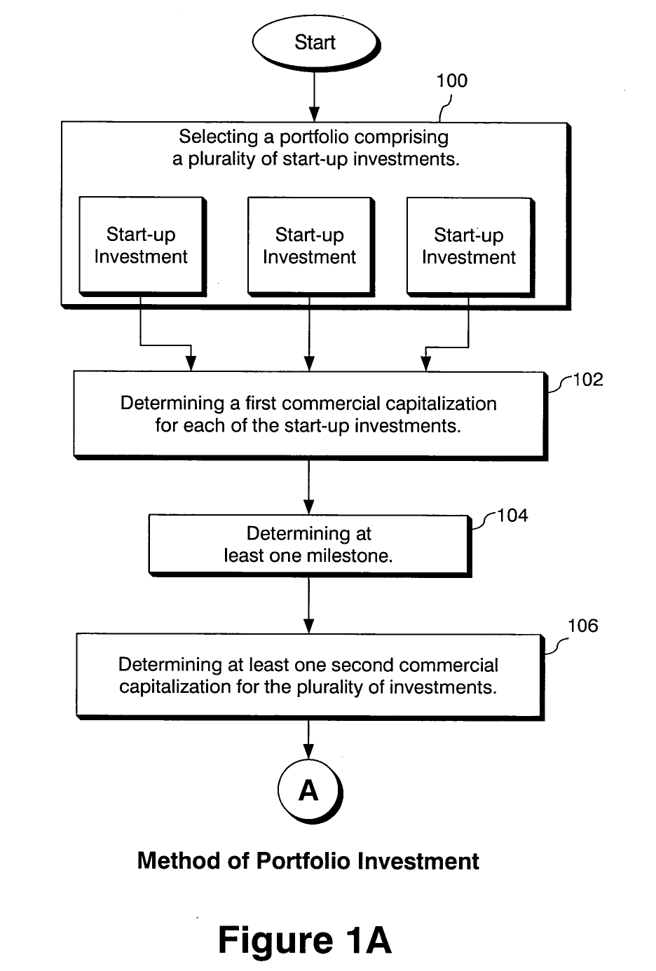

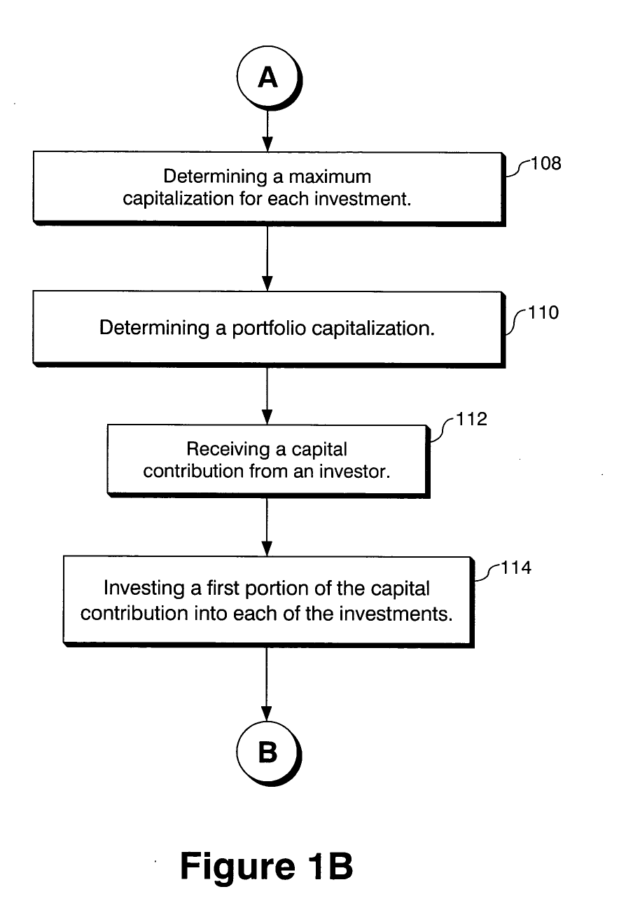

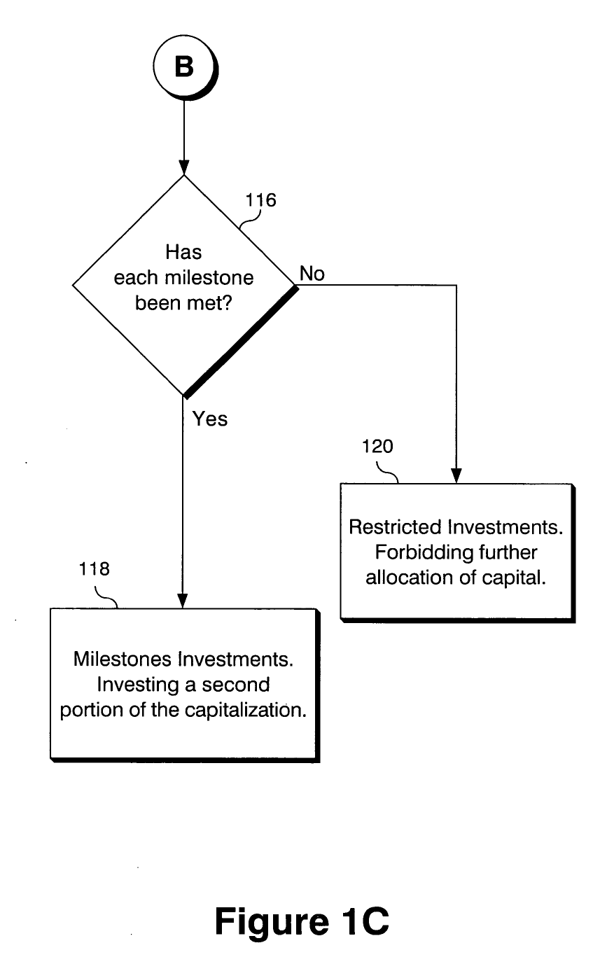

Referring now to FIGS. 1A-1C, a portfolio investment method is illustrated. The portfolio investment method includes, selecting a portfolio comprising a plurality of startup investments (step 100) and determining a first commercial capitalization for each of the plurality of startup investments (step 102). At least one milestone for each of the plurality of investments is determined (step 104). Milestones are objective criteria that determine if the second and further commercial capitalizations are invested in the investment. At least one second commercial capitalization is determined for each of the plurality investments (step 106) and a third, or further commercial capitalizations are within the scope of the invention. A maximum capitalization for each of the plurality investments is determined by summing the first and second commercial capitalizations for each of the plurality of investments (step 108) and the portfolio capitalization is determined (step 110). In one embodiment, the portfolio capitalization equals the sum of the maximum capitalizations for the plurality of investments. In another embodiment, the portfolio capitalization is a value greater than the sum of the maximum capitalization to account for additional central costs for managing the fund.

The above steps prepare the portfolio so that investors can make a capital contribution. Additional steps include, receiving a capital contribution from an investor (step 112), wherein the sum of the capital contributions from investors equals the portfolio capitalization. Preferably, each investor makes at least a minimum predetermined contribution. If the sum of the capital contributions does not equal the portfolio capitalization the portfolio can be considered not funded and the investors are returned their capital contribution. Alternately, the manager of the portfolio can remove one or more of the investments from the portfolio, reducing the portfolio capitalization to approximate to the sum of the capital contributions. The decision of which investment should be removed from the portfolio can also be determined by a vote of the investors. The vote can be determined by either a majority (51%), or a supermajority (e.g. a range of about 70% through about 90%), and the vote of the investors can be taken on a per-investor, or preferably, a per-share of capital contribution basis. The steps outlined below assume that the portfolio is fully funded (i.e. the capital contribution equals the portfolio capitalization).

Further, the capital contribution of each investor can be varied, i.e. each investor can invest any amount into the fund. Also, the capital contributions can be equal, for example, every investor must invest $50,000 or tiered where the investor must invest in preset increments, for example, $50,000 or multiples of $50,000.

A first portion of the capital contribution is invested into each of the plurality of investments (step 114). The allocation of the first portion to each of the plurality of investments is less than or equal to the first commercial capitalization of each of the plurality of investments. This prevents money allocated for one investment from being invested into a different investment. Additionally, this sets an investment ceiling so the investors know how much they stand to lose at every stage of the investment. Once the first portion is invested, the investment is allowed to operate before determining if the milestone for each of the plurality of investments is met (step 116). The plurality of investments where the milestone is met are milestone investments and the investment of a second portion of the capital contribution into each of the milestone investments is permitted (step 118). Similar restrictions on investment, that the second portion is less than or equal to the second commercial capitalization of each milestone investment, are enforced. This again serves to protect the investor as above. Lastly, the plurality of investments where the milestone is not met are restricted investments and further investment in the restricted investments, other than the first commercial capitalization, is forbidden (step 120). Forbidding investment in the restricted investment is a key element to the set up and operation of the fund. Milestones determine the investments that are and are not worthy of further investment. A non-profitable investment should not receive further funding to prevent the unnecessary loss of capital. However, a restricted investment can be profitable but not worthy of further funding. For example, a restricted investment can be a profitable off-Broadway show with 75% attendance which has not reached its milestone of 90% attendance to permit the investment of the second commercial capitalization for the Broadway transfer.

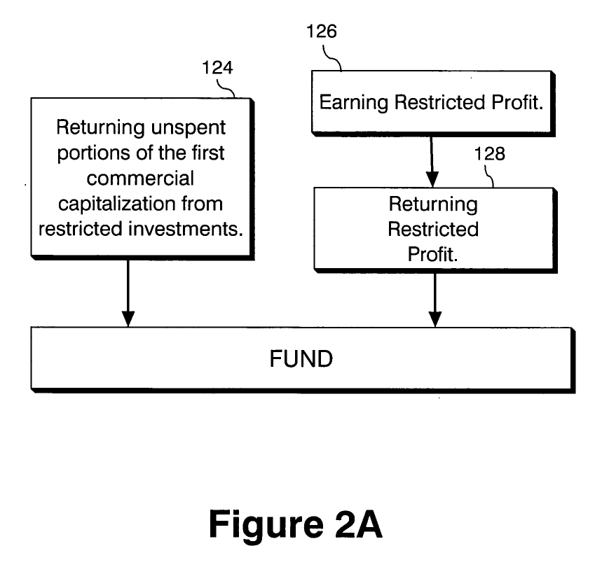

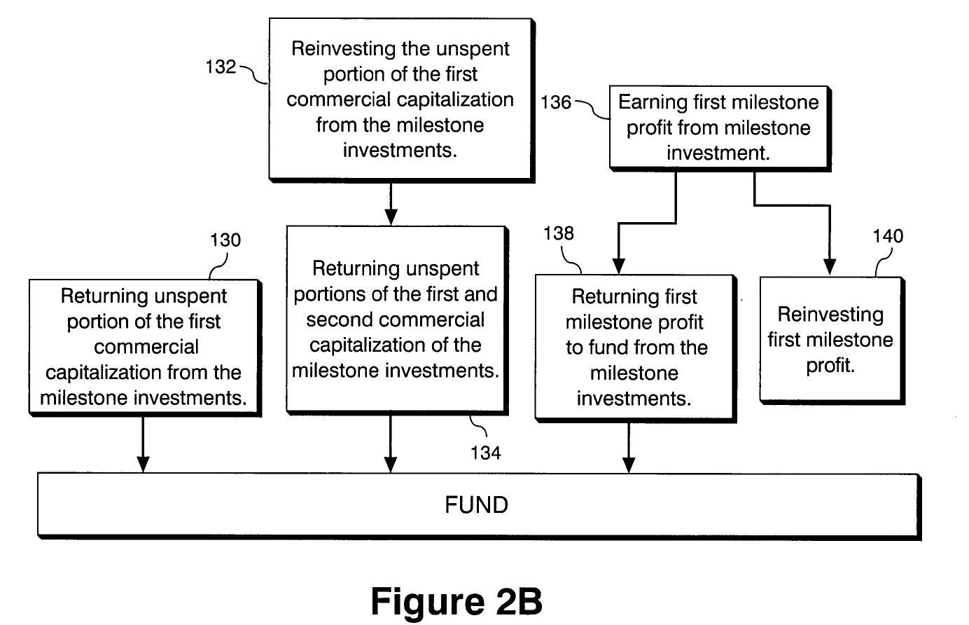

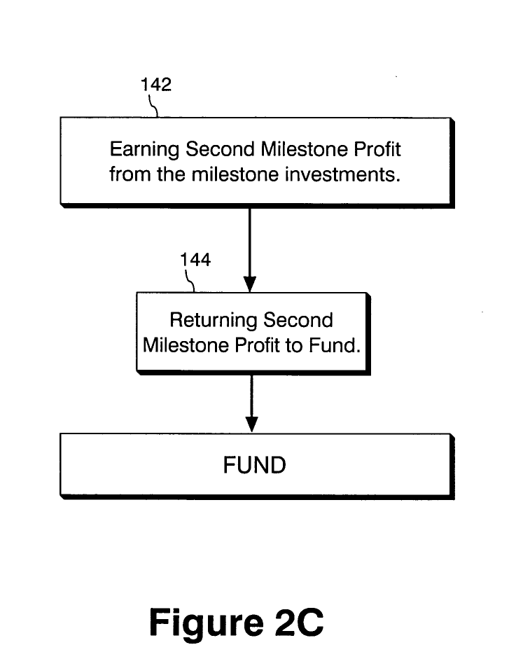

The above steps describe the set up and investment steps of the portfolio. Referring now to FIGS. 2A-2c, the steps of handling the remaining capital and profits are described. First, the invention may preferably include a fund for implementing investments in the portfolio. The fund can comprise any appropriate legal entity, for example, a limited liability company (LLC) or a limited liability partnership (LLP). The fund can be specific for each portfolio or can oversee multiple portfolios. In one embodiment, the fund can be limited so that it cannot operate outside of the initially invested portfolio. Once the fund is created and the investments are capitalized, money can flow from the investments to the fund by numerous means. FIG. 2A illustrates the steps for a restricted investment. Any of an unspent portion of the first commercial capitalization and a full amount of the second commercial capitalization can be returned to the fund (step 124). Additionally, a restricted profit can be earned from the restricted investments (step 126) and returned to the fund (step 128).

Further, FIG. 2B illustrates the steps for the milestone investment, any of the unspent portion of the first capitalization prior to investing the second portion can be returned to the fund (step 130), reinvested into the milestone investment as an addition to the second portion (step 132), or divided between the two. All of an unspent portion of the first and the second commercial capitalizations of the milestone investments can be returned to the fund (step 134). A first milestone profit can be earned from the milestone investment prior to investing the second portion (step 136). The first milestone profit can be returned to the fund (step 138), reinvested into the milestone investment that earned the profit (step 140), or portions of the first milestone profit can be divided between the two. FIG. 2C illustrates a second milestone profit can be earned (step 142) from the milestone investment after investing the second portion. Any unspent first milestone profit plus a full amount of the second milestone profit can be returned to the fund (step 144).

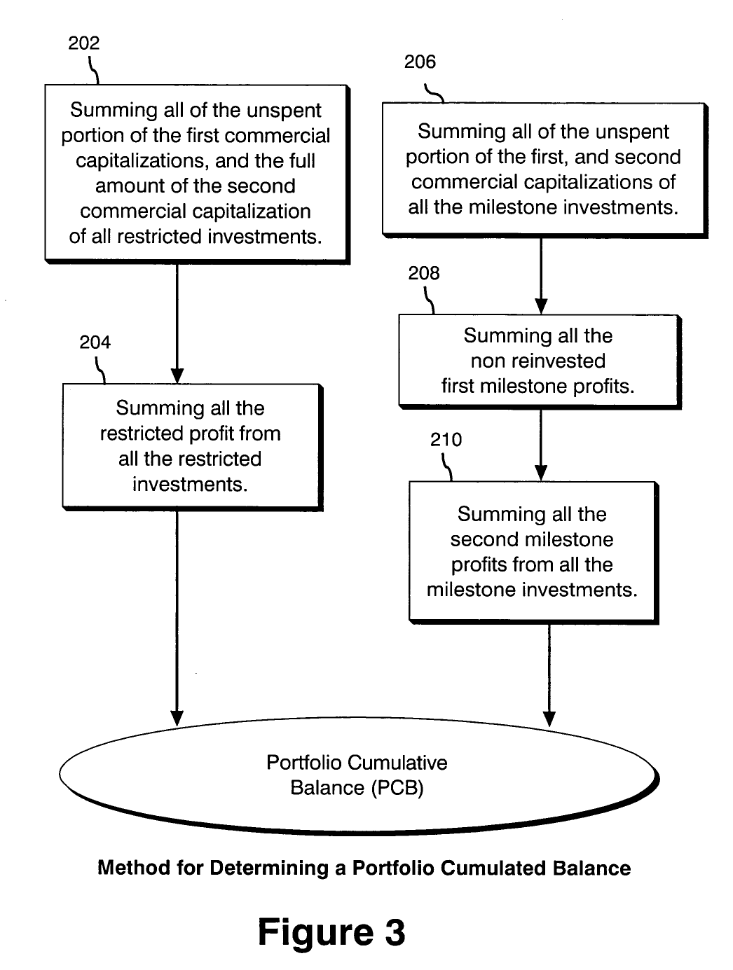

Once the unspent capital and profits are returned to the fund, it must be distributed to the investors. An embodiment, as illustrated in FIG. 3, determines a portfolio cumulated balance. Determining a portfolio cumulated balance includes the steps of summing the entire unspent portion of the first commercial capitalization and the full amount of the second commercial capitalization of all the restricted investments (step 202). All the restricted profits from the restricted investments are also summed (step 204). Alternately, or additionally, the entire unspent portion of the first and the second commercial capitalizations of all the milestone investments can be summed (step 206) as well as summing all first milestone profits from all the milestone investments (step 208) that were not reinvested in the milestone investment that generated the profit. All the second milestone profits from all the milestone investments can also be summed (step 210). The above steps create a portfolio cumulated balance for distribution to the investors. This preferred embodiment looks at the total amount of the return to the fund from all of the investments prior to distribution.

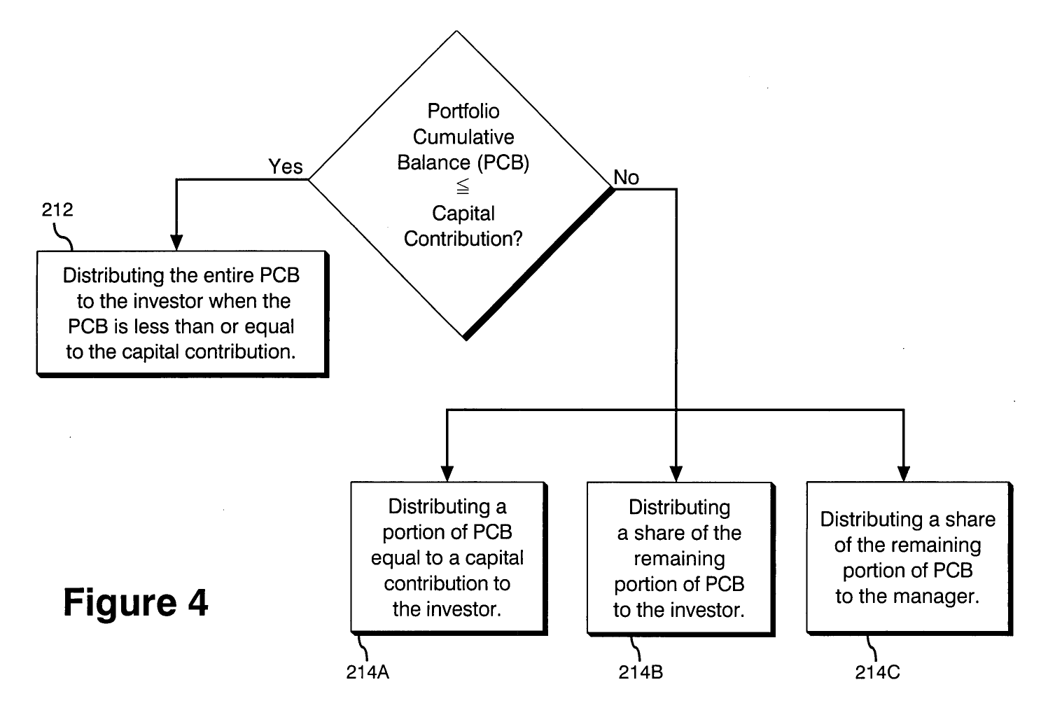

FIG. 4 illustrates a distribution embodiment wherein the portfolio cumulated balance is compared to the capital contribution and when the portfolio cumulated balance is less than or equal to the capital contribution, the investors receive a pro rata distribution of the entire portfolio cumulated balance (step 212). Alternately, when the portfolio cumulated balance is greater than the capital contribution, the investor receives a portion of the portfolio cumulated balance equal to his or her capital contribution (step 214A), and the remaining portion of the portfolio cumulated balance can be shared between the investor (step 214B) and the manager (step 214C) according to the fund's rules of distribution.

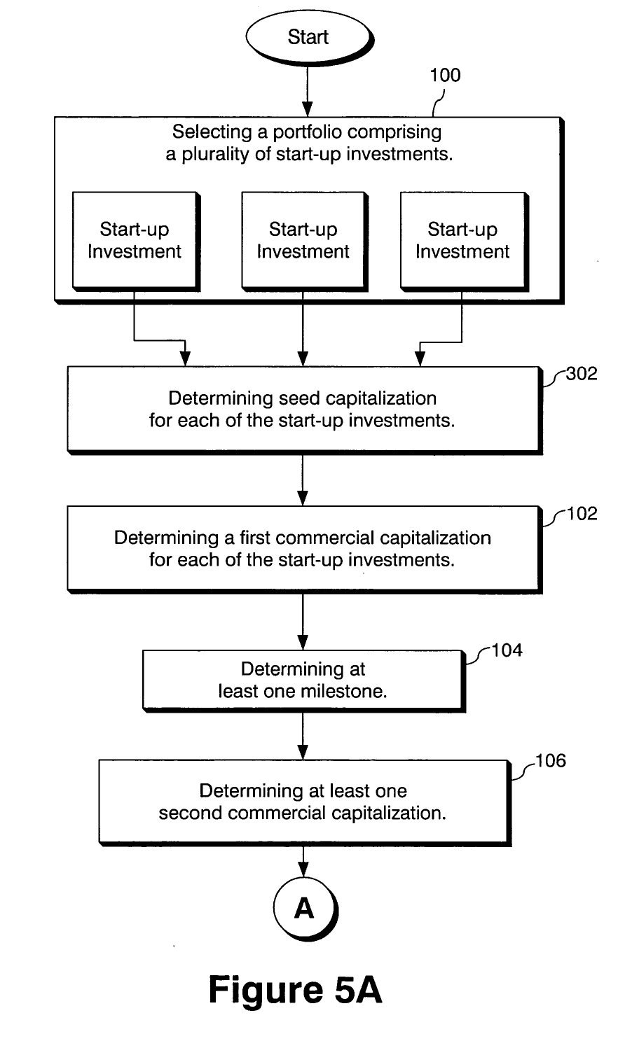

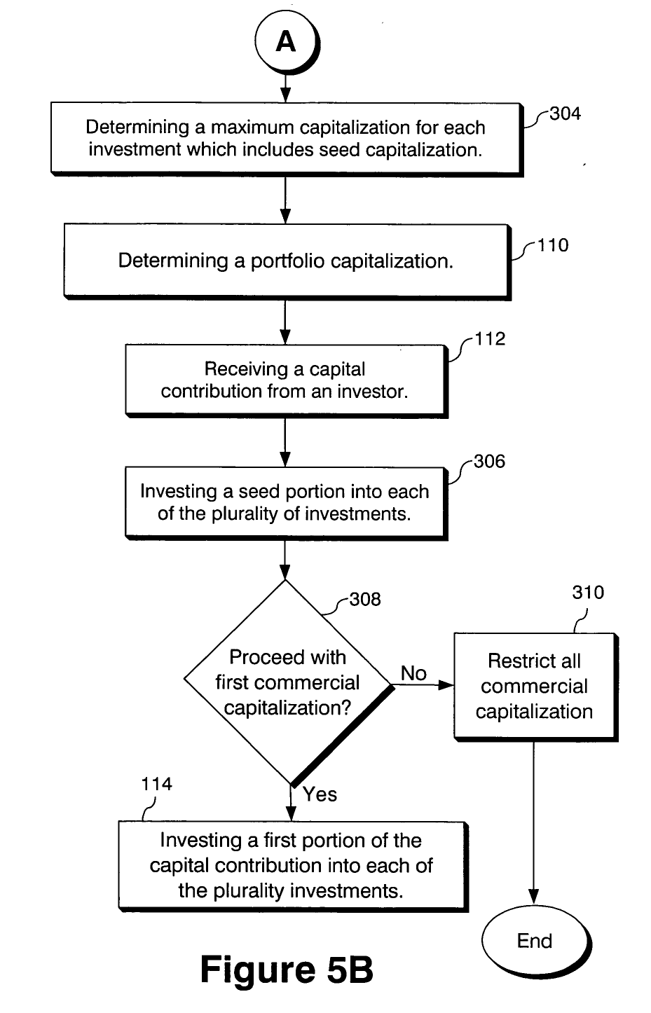

Referring now to FIGS. 5A and 5B, another embodiment of a portfolio is illustrated and the steps of the previous method, described in FIGS. 1A-1C above, are also included. The investment method further includes the step of determining a seed capitalization for each of the plurality of investments (step 302). The maximum capitalization is determined for each of the investments (step 304), similar to step 108. However, the maximum capitalization now can equal the sum of the seed capitalization, and the first and second commercial capitalizations for each of the plurality of investments. Next, a seed portion of the capital contribution can be invested into each of the plurality of investments prior to investing the first portion (step 306). The allocation of the seed portion to each of the plurality of investments is less than or equal to the seed capitalization of each of the plurality of investments. After a seed portion has been invested, a decision can be taken to proceed with the first commercial capitalization (step 308) or to restrict all commercial capitalization (step 310). As above the unspent portions can now include unspent seed capitalization and can be pooled and distributed as above.

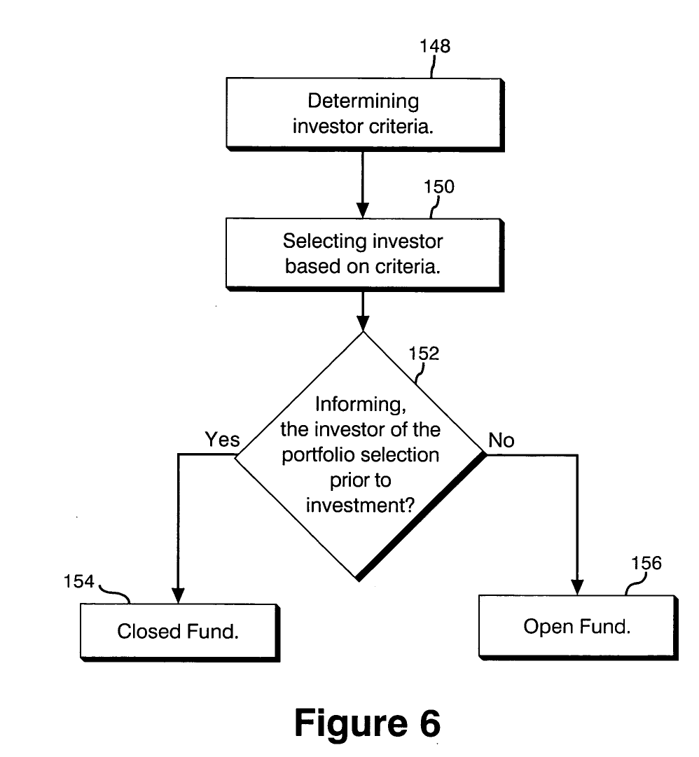

FIG. 6 illustrates different methods for selecting and informing the investor. These steps include determining criteria for the investor (step 148) and selecting the investor based on criteria (step 150). These steps can be performed prior to receiving the capital contribution. Objective criteria can be such as are required under National or State regulations for the private or public solicitation of investment.

Additionally, investors can invest their capital contribution either before or after the investments are selected (step 152). A portfolio can be configured wherein that, prior to receiving the capital contribution, the investor is informed of the first and second commercial capitalizations, the maximum capitalization for each of the investments, the portfolio capitalization and the milestone for each of the investments (step 154), i.e. the closed fund. The open fund does not inform the investors of the above information until after the capital contribution is received (step 156). Further, a semi-closed fund can be configured wherein for some of the investments the investor is informed of the first and second commercial capitalizations, the maximum capitalization for each of the investments, and the milestone for each of the investments prior to receiving the capital contribution. For the remainder of the investment in the portfolio, the investors are not provided with the above information until after the capital contribution is received.

Additionally, the fund can receive a plurality of capital contributions from a plurality of investors, and the sum of the plurality of capital contributions can equal the portfolio capitalization and can either be of unequal or of equal value.

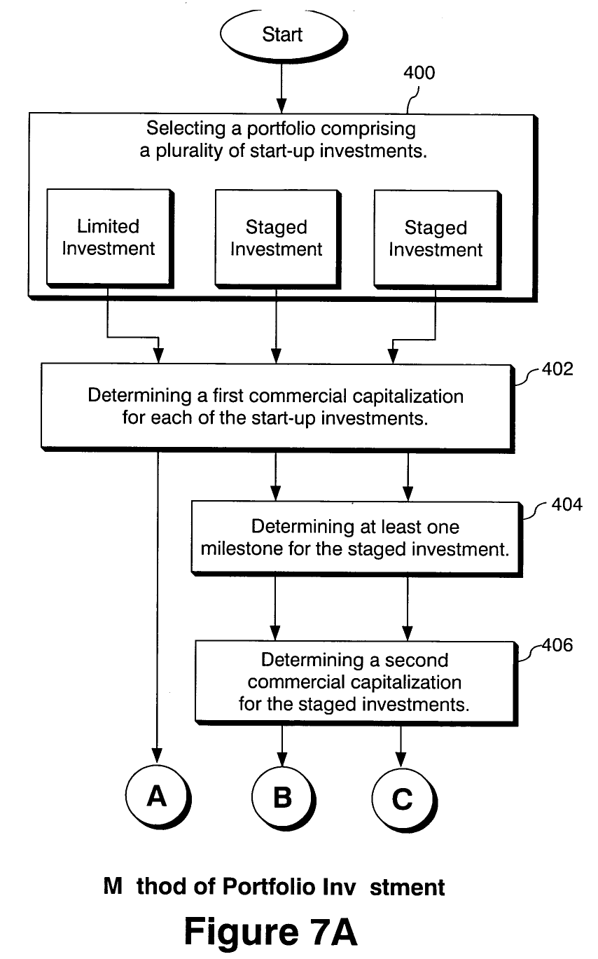

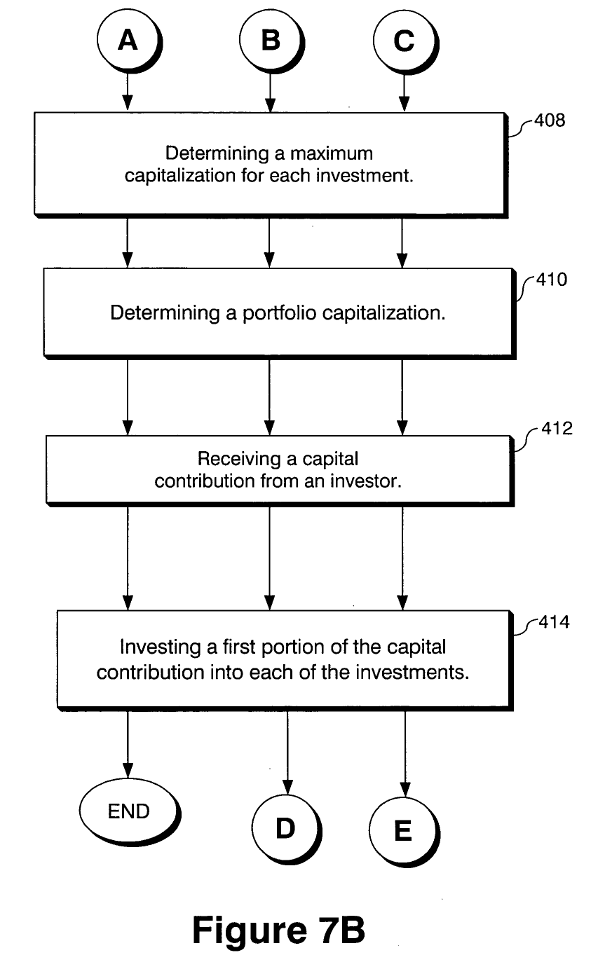

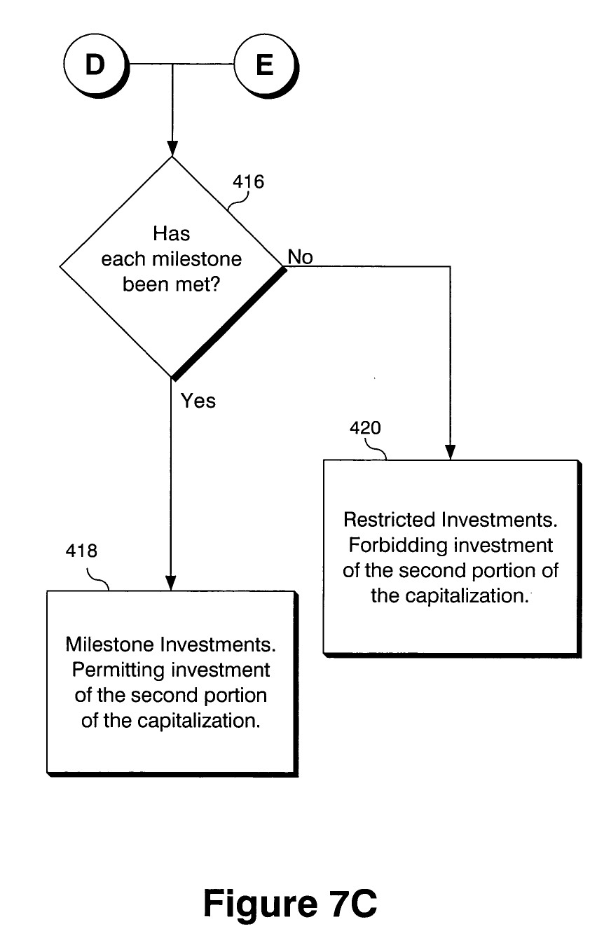

Referring to FIGS. 7A-7C, an alternate embodiment of the present invention is illustrated. A portfolio is selected having a plurality of startup investments including limited investments and staged investments (step 400). A first commercial capitalization is determined for each of the plurality of startup investments (step 402). At least one milestone is determined for each of the staged investments (step 404). At least one second commercial capitalization is determined for each of the staged investments (step 406) and a third, or further commercial capitalizations are within the scope of the invention. A maximum capitalization for each of the plurality investments is determined by summing the first and second commercial capitalizations for each of the plurality of investments (step 408). A portfolio capitalization can be determined (step 410) and a capital contribution is received from an investor (step 412). Next, a first portion of the capital contribution is invested into each of the plurality of investments (step 414). The allocation of the first portion to each of the plurality of investments is less than or equal to the first commercial capitalization of each of the plurality investments. Once the first portion is invested, the investment is allowed to operate. A limited investment does not have a milestone and is not allocated a second commercial capitalization. Once operating, the limited investment can generate a limited profit or can be terminated prior to the depletion of all its first commercial capitalization. The staged investments operate until it can be determined if the milestone for each of the staged investments is met (step 416). The staged investments where the milestone is met are milestone investments and the investment of a second portion of the capital contribution into each of the milestone investments is permitted (step 418). The staged investments where the milestone is not met are restricted investments and further investment in the restricted investments, other than the first commercial capitalization, is forbidden (step 420).

The unspent capital and profits generated by both the limited and staged investments within a portfolio can be pooled to create a cumulated portfolio balance and distributed as above.

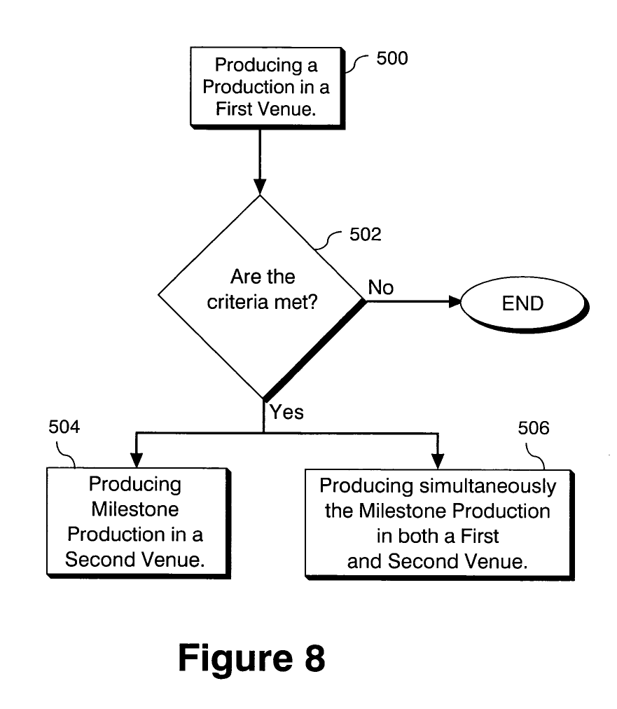

FIG. 8 provides an embodiment of the invention wherein a plurality of investments are productions. When the investment is a production, e.g. a theatrical production, each of the productions can be produced in a separate first venue (step 500) and the first commercial capitalization for each of the productions equals the cost of mounting each of the productions in their respective first venues. Further, the milestone investments are milestone productions and determining a milestone for the investment includes determining objective criteria for the production (step 502). The milestone productions can be produced in a separate second venue terminating the production in the first venue (step 504) or simultaneously with the production in the first venue (step 506). Furthermore, the second commercial capitalization for each of the milestone productions equals the cost of mounting each of the milestone productions in their respective second venues. In this embodiment, the objective criteria can include, but is not limited to ticket sales and weekly revenue against weekly expenditure. These and other objective criteria will be apparent to those of ordinary skill in the arts of producing and financing entertainment projects and productions.

The entertainment embodiment includes first venue production costs and second venue production costs which can include for each venue: fees paid to managers, agents, writers, performers, designers, directors, prop supervisors, costume supervisors, electricians, sound providers and carpenters; expenses including the creation of sets, props, costumes, and wigs, transportation standard consumables, theater rental, maintenance, upkeep, and rehearsal costs including script copying, rehearsal rooms, and travel expenses, advertising, public relations, general administration expenses, including legal fees, accounting fees, and insurance; bonds, reserves, insurance and administration.

One example of an embodiment of the present invention includes receiving the capital contribution for taking a stage musical through a series of workshops and tryouts in the United Kingdom and then to a commercial venue in London and then to a commercial venue in New York. The seed capitalization and first and second commercial capitalizations are determined and the maximum capitalization is calculated. The maximum capitalization for this example is $9,500,000. The seed capitalization is determined to be $1,500,000 (made up of $750,000 in already accrued development costs and $750,000 in future development costs) or 15.8% of the maximum capitalization of the production. In the worst case, the development of the musical may turn out to be unsatisfactory and the whole production aborted during seed capitalization and before commercial capitalization, thereby limiting the investor's risk to less than 16% of the maximum capitalization for that production. The first commercial capitalization for staging the musical at a commercial venue in London is $2,000,000. If the musical fails to achieve its milestone in London i.e. if it operates at a loss or fails to reach milestone profitability, the second capital investment (for a New York production) is forbidden. This limits the investor's risk to less than 37% of the maximum capitalization (i.e. a maximum of $1,500,000 seed capitalization and $2,000,000 first commercial capitalization). However, if the milestone is met, i.e. the London production recoups its development and production costs and is sufficiently profitable, the second capital investment (for a New York production) is permitted and the investors are in a position to share fully in the benefits (and risks) of the final stage. In other words, the final 63% of capital will only be invested if all previous milestones were met. The milestone approach protects the majority of the investment until it is clear that the return on the first portion has justified the investment of the maximum capital.

A further example of an embodiment of the present invention includes receiving the capital contribution for nine theatre productions (wherein productions have milestones) with a maximum capitalization of $8,509,268 (made up of a maximum capitalization for each production of 1) $836,344; 2) $1,680,590; 3) $1,631,155; 4) $1,680,590; 5) $1,608,354; 6) $107,224; 7) $107,224; 8) $428,894; 9) $428,894. Theatrical productions numbers 1, 3, 6, 7, 8 and 9 are limited investments; i.e. their maximum capitalizations are calculated from only their seed and first commercial capitalizations. Theatrical productions numbers 2, 4, and 5 are staged investments and have multiple milestones, (the milestone being to exceed 80% attendance level at the off Broadway venue for at least three months before permitting use of the second commercial capitalization for a Broadway transfer). In the case of productions 2 and 4, the seed capitalization is $180,590, first commercial capitalization is $700,000 and second commercial capitalization is $800,000. The second commercial capitalization for productions 2, 4, and 5 will be invested only if their respective milestone is achieved. In the case of production number 5, the seed capitalization is $108,354, first commercial capitalization is $700,000 and second commercial capitalization is $800,000, which is to be invested only if its milestone is achieved. Data tables can be created of weekly running costs and box office returns at proposed venues and software can be employed to calculate the return to the investor with any hypothetical or predicted outcome (in terms of audience attendance and length of run) for the productions.

An example of an outcome which illustrate the benefits of spreading the risk and staging the investments with rules of distribution based on the cumulated return of the entire portfolio: six out of nine of the theatrical productions (i.e. productions 1, 2, 3, 4, 8, and 9) are predicted to fail badly, i.e. 25% attendance for 2 months where the productions fail to recoup any of the seed and first commercial capitalizations. These productions also run at a substantial weekly loss during the two months before they close, thereby eating into the first commercial capitalization's reserve to cover weekly losses incurred in a loss making production. Theatrical productions 6 and 7 are predicted to break even, and theatrical production 5 is predicted to be the only success (i.e. six months off Broadway at 90% attendance followed by transfer to Broadway for a four year six month run at 80% attendance). The outcome for the investor, as calculated by the software, is a total return of the investment (i.e. the return of $8,509,268) to the investor and a profit of $10,271,350, (to be split 50% to the investor and 50% to the managing or general partner).

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another is also fully intended and contemplated. It is also to be understood that the drawings are exemplary and they are conceptual in nature. It is the intention, therefore, to be limited only as indicated by the scope of the claims appended hereto.

1. A portfolio investment method comprising:
selecting a portfolio comprising a plurality of startup investments;
determining a first commercial capitalization for each of the plurality of startup investments;
determining at least one milestone for each of the plurality of investments;
determining at least a second commercial capitalization for each of the plurality investments;
determining a maximum capitalization for each of the plurality of investments which equals the sum of the first and the second commercial capitalizations for each of the plurality of investments;
determining a portfolio capitalization;
receiving a capital contribution from at least one investor, wherein a sum of the capital contribution from the at least one investor is greater than or equal to the portfolio capitalization;
investing a first portion of the capital contribution into each of the plurality of investments, wherein the allocation of the first portion to each of the plurality of investments is less than or equal to the first commercial capitalization of each of the plurality investments;
determining if a milestone for each of the plurality of investments is met, wherein the plurality of investments where a milestone is met are milestone investments and the plurality of investments where a milestone is not met are restricted investments;
permitting the investment of a second portion of the capital contribution into each of the milestone investments, wherein the second portion is less than or equal to the second commercial capitalization of each milestone investment; and
forbidding investment in the restricted investments other than the first commercial capitalization.

2. The method of claim 1, wherein the above steps are performed by a fund.

3. The method of claim 2, further comprising:
returning all of an unspent portion of the first commercial capitalization and a full amount of the second commercial capitalization of the restricted investments to the fund.

4. The method of claim 3, further comprising:
earning a restricted profit from the restricted investments; and
returning the restricted profit to the fund.

5. The method of claim 4, further comprising:
determining a portfolio cumulated balance comprising:
summing all of the unspent portion of the first commercial capitalization and the full amount of the second commercial capitalization of all the restricted investments; and
summing all restricted profit from all the restricted investments.

6. The method of claim 5, further comprising:
when the portfolio cumulated balance is less than or equal to the capital contribution, distributing, to the investor, the entire portfolio cumulated balance; and
when the portfolio cumulated balance is greater than the capital contribution, distributing, to the investor, a portion of the portfolio cumulated balance equal to the capital contribution, and a share of the remaining portion of the portfolio cumulated balance.

7. The method of claim 2, further comprising:
returning an amount of an unspent portion of the first commercial capitalization of the milestone investments to the fund; and
reinvesting a remainder of the unspent portion of the first commercial capitalization into the milestone investment that contains the unspent portion.

8. The method of claim 7, further comprising:
returning the unspent portion of the second commercial capitalization of the milestone investments to the fund.

9. The method of claim 7, further comprising:
earning a first milestone profit from the milestone investment prior to investing the second portion;
returning a portion of the first milestone profit to the fund; and
reinvesting a remainder of the first milestone profit into the milestone investment that earned the profit.

10. The method of claim 9, further comprising:
earning a second milestone profit from the milestone investment after investing the second portion; and
returning a full amount of the second milestone profit to the fund.

11. The method of claim 10, further comprising:
determining a portfolio cumulated balance comprising:
summing all of the unspent portion of the first and the second commercial capitalizations of all the milestone investments;
summing all non-reinvested first milestone profits from all the milestone investments; and
summing all the second milestone profits from all the milestone investments.

12. The method of claim 11, further comprising:
when the portfolio cumulated balance is less than or equal to the capital contribution, distributing, to the investor, the entire portfolio cumulated balance; and
when the portfolio cumulated balance is greater than the capital contribution, distributing, to the investor, a portion of the portfolio cumulated balance equal to the capital contribution, and a share of the remaining portion of the portfolio cumulated balance.

13. The method of claim 2, further comprising:
returning all of an unspent portion of the first commercial capitalization and a full amount of the second commercial capitalization of the restricted investments to the fund;
returning an amount of an unspent portion of the first commercial capitalization of the milestone investments to the fund;
reinvesting a remainder of the unspent portion of the first commercial capitalization into the milestone investment that contains the unspent portion;
returning the unspent portion of the second commercial capitalization of the milestone investments to the fund;
earning a restricted profit from the restricted investments;
returning the restricted profit to the fund;
earning a first milestone profit from the milestone investment prior to investing the second portion;
returning an amount of the first milestone profit to the fund;
reinvesting a remainder of the first milestone profit into the milestone investment that earned the profit
earning a second milestone profit from the milestone investment after investing the second portion;
returning a full amount of the second milestone profit to the fund;
determining a portfolio cumulated balance comprising:
summing all of the unspent portion of the first commercial capitalization and the full amount of the second commercial capitalization of all the restricted investments;
summing all of the unspent portion of the first and the second commercial capitalizations of all the milestone investments;
summing all restricted profit from all the restricted investments;
summing all non reinvested first milestone profits from all the milestone investments;
summing all the second milestone profits from all the milestone investments;
when the portfolio cumulated balance is less than or equal to the capital contribution, distributing, to the investor, the entire portfolio cumulated balance; and
when the portfolio cumulated balance is greater than the capital contribution, distributing, to the investor, a portion of the portfolio cumulated balance equal to the capital contribution, and a share of the remaining portion of the portfolio cumulated balance.

14. The method of claim 1, wherein the portfolio capitalization is greater than or equal to the sum of the maximum capitalizations for the plurality of investments.

15. The method of claim 1 further comprising:
determining a seed capitalization for each of the plurality of investments;
determining the maximum capitalization for each of the investments which equals the sum of the seed capitalization, and the first and the second commercial capitalizations for each of the plurality of investments;
prior to investing the first portion, investing a seed portion of the capital contribution into each of the plurality of investments, wherein the allocation of the seed portion to each of the plurality of investments is less than or equal to the seed capitalization of each of the plurality of investments.

16. The method of claim 15, wherein the above steps are performed by a fund.

17. The method of claim 16, further comprising:
returning all of an unspent portion of the seed capitalization to the fund;
returning all of an unspent portion of the first commercial capitalization and a full amount of the second commercial capitalization of the restricted investments to the fund;
returning an amount of an unspent portion of the first commercial capitalization of the milestone investments to the fund;
reinvesting a remainder of the unspent portion of the first commercial capitalization into the milestone investment that contains the unspent portion;
returning the unspent portion of the second commercial capitalization of the milestone investments to the fund;
earning a restricted profit from the restricted investments;
returning the restricted profit to the fund;
earning a first milestone profit from the milestone investment prior to investing the second portion;
returning a portion of the first milestone profit to the fund;
reinvesting a remainder of the first milestone profit into the milestone investment that earned the profit
earning a second milestone profit from the milestone investment after investing the second portion;
returning a full amount of the second milestone profit to the fund;
determining a portfolio cumulated balance comprising:
summing all of the unspent portion of the seed capitalization of all investments
summing all of the unspent portion of the first commercial capitalization and the full amount of the second commercial capitalization of all the restricted investments;
summing all of the unspent portion of the first and the second commercial capitalizations of all the milestone investments;
summing all restricted profit from all the restricted investments;
summing all non reinvested first milestone profits from all the milestone investments;
summing all the second milestone profits from all the milestone investments;
when the portfolio cumulated balance is less than or equal to the capital contribution, distributing, to the investor, the entire portfolio cumulated balance; and
when the portfolio cumulated balance is greater than the capital contribution, distributing, to the investor, a portion of the portfolio cumulated balance equal to the capital contribution, and a share of the remaining portion of the portfolio cumulated balance.

18. The method of claim 15, wherein the seed capitalization comprises only the rights in the investment.

19. The method of claim 1, further comprising:
determining criteria for the investor; and
selecting the investor based on the criteria.

20. The method of claim 1, further comprising:
prior to the receiving step, informing the investor of the first commercial capitalization, the second commercial capitalization, and the maximum capitalization for each of the plurality of investments and the portfolio capitalization.

21. The method of claim 1, further comprising:
prior to the receiving step, informing the investor of the milestone for each of the investments.

22. The method of claim 15, further comprising:
prior to the receiving step, informing the investor of the seed capitalization, the first commercial capitalization, the second commercial capitalization, and the maximum capitalization for each of the investments and the portfolio capitalization.

23. The method of claim 1, further comprising:
receiving a plurality of capital contributions from a plurality of investors, wherein a sum of the plurality of capital contributions is greater than or equal the portfolio capitalization.

24. The method of claim 1, further comprising:
receiving a plurality of capital contributions from a plurality of investors, wherein a sum of the plurality of capital contributions is less than the portfolio capitalization;
optionally, reducing the portfolio capitalization, by removing at least one of the plurality of investments, to approximately equal the sum of the plurality of capital contributions; and
optionally, returning the plurality of capital contributions to the plurality of investors.

25. The method of claim 1, further comprising:
receiving a plurality of capital contributions from a plurality of investors, wherein each of the plurality of capital contributions are of equal value.

26. The method of claim 1, further comprising:
receiving a plurality of capital contributions from a plurality of investors, wherein each of the plurality of capital contributions are of varied value.

27. The method of claim 1, further comprising:
receiving a plurality of capital contributions from a plurality of investors, wherein each of the plurality of capital contributions are of a tiered value.

28. A portfolio investment method comprising:
selecting a portfolio comprising a plurality of startup investments including limited investments and staged investments;
determining a first commercial capitalization for each of the plurality of startup investments;
determining at least one milestone for each of the staged investments;
determining at least a second commercial capitalization for each of the staged investments;
determining a maximum capitalization for each of the plurality investments which equals the sum of the first and the second commercial capitalizations for each of the plurality of investments;
determining a portfolio capitalization;
receiving a capital contribution from at least one investor, wherein a sum of the capital contribution from the at least one investor equals the portfolio capitalization;
investing a first portion of the capital contribution into each of the plurality of investments, wherein the allocation of the first portion to each of the plurality of investments is less than or equal to the first commercial capitalization of each of the plurality investments;
determining if the milestone for each of the staged investments is met, wherein the staged investments where the milestone is met are milestone investments and the staged investments where the milestone is not met are restricted investments;
permitting the investment of a second portion of the capital contribution into each of the milestone investments, wherein the second portion is less than or equal to the second commercial capitalization of each milestone investment; and
forbidding investment in the restricted investments other than the first commercial capitalization.

29. The method of claim 28, wherein the above steps are performed by a fund.

30. The method of claim 29, further comprising:
returning an unspent portion of the first commercial capitalization of the limited investments to the fund.

31. The method of claim 29, further comprising:
earning a limited profit from the limited investments; and
returning the limited profit to the fund.

32. The method of claim 31, further comprising:
determining a portfolio cumulated balance comprising:
summing all of the unspent portion of the first commercial capitalization of all the limited investments; and
summing the limited profit.

33. The method of claim 32, further comprising:
when the portfolio cumulated balance is less than and equal to the capital contribution, distributing, to the investor, the entire portfolio cumulated balance; and
when the portfolio cumulated balance is greater than the capital contribution, distributing, to the investor, a portion of the portfolio cumulated balance equal to the capital contribution; and a portion of a remaining portion of the portfolio cumulated balance.

34. The method of claim 29, further comprising:
returning all of an unspent portion of the first commercial capitalization and a full amount of the second commercial capitalization of the restricted investments to the fund.

35. The method of claim 34, further comprising:
earning an restricted profit from the restricted investments; and
returning the restricted profit to the fund.

36. The method of claim 35, further comprising:
determining a portfolio cumulated balance comprising:
summing all of the unspent portion of the first commercial capitalization and the full amount of the second commercial capitalization of all the restricted investments; and
summing the restricted profit.

37. The method of claim 36, further comprising:
when the portfolio cumulated balance is less than and equal to the capital contribution, distributing, to the investor, the entire portfolio cumulated balance; and
when the portfolio cumulated balance is greater than the capital contribution, distributing, to the investor, a portion of the portfolio cumulated balance equal to the capital contribution, and a portion of a remaining portion of the portfolio cumulated balance.

38. The method of claim 29, further comprising:
returning an amount of an unspent portion of the first and the second commercial capitalizations of the milestone investments to the fund; and
reinvesting a remainder of the unspent portion of the first commercial capitalization into the milestone investment that contains the unspent portion.

39. The method of claim 38, further comprising:
earning a first milestone profit from the milestone investment prior to investing the second portion;
returning a portion of the first milestone profit to the fund; and
reinvesting a remainder of the first milestone profit into the milestone investment that earned the profit.

40. The method of claim 39, further comprising:
earning a second milestone profit from the milestone investment after investing the second portion; and
returning a full amount of the second milestone profit to the fund.

41. The method of claim 40, further comprising:
determining a portfolio cumulated balance comprising:
summing all of the unspent portion of the first and the second commercial capitalizations of all the milestone investments;
summing all first milestone profits from all the milestone investments; and
summing all the second milestone profits from all the milestone investments.

42. The method of claim 41, further comprising:
when the portfolio cumulated balance is less than and equal to the capital contribution, distributing, to the investor, the entire portfolio cumulated balance; and
when the portfolio cumulated balance is greater than the capital contribution, distributing, to the investor, a portion of the portfolio cumulated balance equal to the capital contribution, and a portion of a remaining portion of the portfolio cumulated balance.

43. The method of claim 29, further comprising:
returning all of an unspent portion of the first commercial capitalization of the limited investments to the fund;
returning all of an unspent portion of the first commercial capitalization and a full amount of the second commercial capitalization of the restricted investments to the fund;
returning all of an unspent portion of the first and the second commercial capitalizations of the milestone investments to the fund;
earning a limited profit from the limited investments;
returning the limited profit to the fund;
earning an restricted profit from the restricted investments;
returning the restricted profit to the fund;
earning a first milestone profit from the milestone investment prior to investing the second portion;
returning a portion of the first milestone profit to the fund;
reinvesting a remainder of the first milestone profit into the milestone investment that earned the profit;
earning a second milestone profit from the milestone investment after investing the second portion;
returning a full amount of the second milestone profit to the fund;
determining a portfolio cumulated balance comprising:
summing all of the unspent portion of the first commercial capitalization of all the limited investments;
summing all limited profits;
summing all of the unspent portions of the first commercial capitalization and the full amount of the second commercial capitalization of all the restricted investments;
summing all the restricted profits;
summing all the first milestone profits;
summing all the second milestone profits;
when the portfolio cumulated balance is less than and equal to the capital contribution, distributing, to the investor, the entire portfolio cumulated balance; and
when the portfolio cumulated balance is greater than the capital contribution, distributing, to the investor, a portion of the portfolio cumulated balance equal to the capital contribution, and a portion of a remaining portion of the portfolio cumulated balance.

44. The method of claim 28, wherein the portfolio capitalization is greater than or equal to the sum of the maximum capitalizations for the plurality of investments.

45. The method of claim 28 further comprising:
determining a seed capitalization for each of the plurality of investments;
determining the maximum capitalization for each of the investments which equals the sum of the seed capitalization, and the first and the second commercial capitalizations for each of the plurality of investments;
prior to investing a first portion, investing a seed portion of the capital contribution into each of the plurality of investments, wherein the allocation of the seed portion to each of the plurality of investments is less than or equal to the seed capitalization of each of the plurality of investments.

46. The method of claim 45, wherein the above steps are performed by a fund.

47. The method of claim 46, further comprising:
returning all of an unspent portion of the seed and the first commercial capitalization of the limited investments to the fund;
returning all of an unspent portion of the seed and the first commercial capitalization and a full amount of the second commercial capitalization of the restricted investments to the fund;
returning all of an unspent portion of the seed capitalization, and the first and the second commercial capitalizations of the milestone investments to the fund;
earning a limited profit from the limited investments;
returning the limited profit to the fund;
earning an restricted profit from the restricted investments;
returning the restricted profit to the fund;
earning a first milestone profit from the milestone investment prior to investing the second portion;
returning a portion of the first milestone profit to the fund;
reinvesting a remainder of the first milestone profit into the milestone investment that earned the profit;
earning a second milestone profit from the milestone investment after investing the second portion;
returning a full amount of the second milestone profit to the fund;
determining a portfolio cumulated balance comprising:
summing all of the unspent portion of the seed capitalization and the first commercial capitalization of all the limited investments;
summing all limited profits;
summing all of the unspent portions of the seed capitalization and the first commercial capitalization and the full amount of the second commercial capitalization of all the restricted investments;
summing all the restricted profits;
summing all the first milestone profits; and
summing all the second milestone profits.

48. The method of claim 47, further comprising:
when the portfolio cumulated balance is less than and equal to the capital contribution, distributing, to the investor, the entire portfolio cumulated balance; and
when the portfolio cumulated balance is greater than the capital contribution, distributing, to the investor, a portion of the portfolio cumulated balance equal to the capital contribution, and a portion of a remaining portion of the portfolio cumulated balance.

49. The method of claim 45, wherein the seed capitalization comprises only the rights in the investment.

50. The method of claim 1, wherein the plurality of investments are productions.

51. The method of claim 50, further comprising:
producing each of the productions in a separate first venue and the first commercial capitalization for each of the productions equals a first venue production cost for each of the productions to produce each of the productions in the respective first venue.

52. The method of claim 51, wherein the milestone investments are milestone productions, further comprising:
producing each of the milestone productions in a separate second venue and the second commercial capitalization for each of the milestone productions equals a second venue production cost for each of the milestone productions to produce each of the milestone productions in the respective second venue.

53. The method of claim 52, further comprising:
producing some of the milestone productions in both the first venue and the second venue simultaneously.

54. The method of claim 50 wherein the determining a milestone for the investment comprises determining an objective performance based criteria for the production.

55. The method of claim 54, wherein the objective performance based criteria are ticket sales and weekly revenue against weekly expenditure

56. The method of claim 1, further comprising:
after the receiving step, informing the investor of the first commercial capitalization, the second commercial capitalization, and the maximum capitalization for each of the plurality of investments and the portfolio capitalization.

57. The method of claim 1, further comprising:
after the receiving step, informing the investor of the milestone for each of the investments.

58. The method of claim 15, further comprising:
after the receiving step, informing the investor of the seed capitalization, the first commercial capitalization, the second commercial capitalization, and the maximum capitalization for each of the investments and the portfolio capitalization.

59. The method of claim 1, further comprising:
prior to the receiving step, informing the investor of at least one of the first commercial capitalization, the second commercial capitalization, the milestone, and the maximum capitalization for each of the plurality of investments and the portfolio capitalization; and
after the receiving step, informing the investor of the remainder of the at least one of the first commercial capitalization, the second commercial capitalization, the milestone, and the maximum capitalization for each of the plurality of investments and the portfolio capitalization not informed prior to the receiving step.

60. The method of claim 15, further comprising:
prior to the receiving step, informing the investor of at least one of the seed capitalization, the first commercial capitalization, the second commercial capitalization, and the maximum capitalization for each of the investments and the portfolio capitalization; and
after the receiving step, informing the investor of the remainder of the at least one of the seed capitalization, the first commercial capitalization, the second commercial capitalization, and the maximum capitalization for each of the investments and the portfolio not informed prior to the receiving step.
